(19) United States
(12) Patent Application Publication
(10) Pub. No.: US 2018/0141406 A1
(43) Pub. Date: May 24, 2018

(54) VEHICLE AIR-CONDITIONING SYSTEM AND OPERATING METHOD

(71) Applicant: Mahle International GmbH, Stuttgart (DE)

(72) Inventors: Dirk Neumeister, Stuttgart (DE); Achim Wiebelt, Neustadt (DE)

(21) Appl. No.: 15/573,476

(22) PCT Filed: May 4, 2016
(86) PCT No.: PCT/EP2016/060059

§ 371 Date: Nov. 12, 2017

(30) Foreign Application Priority Data
May 12, 2015 (DE) 10 2015 208 800.6

(51) Int. Cl. B60H 1/00; F25B 21/04

(52) U.S. Cl. CPC B60H 1/00478; F25B 25/00; B60H 1/00385; F25B 21/04

(57) ABSTRACT

A vehicle may include an electric drive having at least one electric motor, at least one battery and at least one power electronic and may be cooled via a cooling circuit. The vehicle may include an air-conditioning system including at least one duct. A refrigeration circuit and a thermoelectric heating device may be arranged in the at least one duct. A control device may be configured/programmed to actuate the air-conditioning system, and may be operable to: activate the refrigeration circuit to cool the interior; operate the thermoelectric heating device as a cooler during a start-up phase of the refrigeration circuit; operate the thermoelectric heating device only as the cooler during the start-up phase of the refrigeration circuit when a cool-down function is activated; and automatically activate the cool-down function when a temperature difference between an actual temperature of the interior and a target temperature of the interior exceeds a predetermined temperature difference threshold value.

### CROSS-REFERENCE TO RELATED APPLICATIONS

This application claims priority to International Application PCT/EP2016/060059 filed on May 4, 2016, and to German Application DE 10 2015 208 800.6 filed on May 12, 2015, the contents of both of which are hereby incorporated by reference in their entirety.

### TECHNICAL FIELD

The present invention relates to a method for operating a vehicle air-conditioning system. The invention relates furthermore to a vehicle air-conditioning system for air-conditioning a vehicle interior and a vehicle equipped with such a vehicle air-conditioning system. Finally, the present invention relates to the use of a thermoelectric heating device.

### BACKGROUND

A vehicle air-conditioning system usually comprises a refrigeration circuit, in which a refrigerant circulates and which has an evaporator for cooling an air flow. Usually, such a refrigeration circuit comprises in addition a condenser and a refrigerant pump for driving the refrigerant in the refrigeration circuit. Via the condenser, heat can be emitted to a heat sink, in particular to the environment of the vehicle. Via the evaporator, heat can be extracted from the air flow. Both in the condenser and also in the evaporator, a phase change takes place in the refrigerant during such a refrigeration process, whereby such a refrigeration circuit operates particularly efficiently. In addition, it is usual to equip a vehicle air-conditioning system with at least one heating device, by means of which the air flow can be heated. Such a heating device can be configured for example as a heat exchanger and can be integrated into a cooling circuit of the vehicle, which serves for the cooling of components of the vehicle. Waste heat from these vehicle components can be used via the cooling circuit and the heat exchanger for heating the air flow. In addition, it is known to use electrically operated heating devices, so that then also the air flow can be heated if no waste heat yet occurs in the cooling circuit. This is the case for example during a start phase or warming-up phase of the vehicle. Such a heating device can expediently also be arranged with respect to the air flow downstream of the evaporator of the refrigeration circuit, whereby a re-heating of the air flow, which has been cooled by means of the evaporator, is possible, a so-called “re-heat function.” In connection with such a re-heat function, the air flow can be cooled down in the evaporator below the dew point by means of the refrigeration circuit, and can subsequently be heated in the heating device to the desired target temperature, whereby finally a drying of the air flow, delivered to the respective vehicle interior, is achieved. This serves on the one hand to increase the comfort conditions and can, on the other hand, be used for the rapid removal of a misting of a windscreen.

After a lengthy standstill of the vehicle, ambient temperature is present in all components of the vehicle and in particular also in all components of the vehicle air-conditioning system. At the starting-up of the vehicle, therefore neither the full heating output of the vehicle air-conditioning system nor the full cooling capacity of the vehicle air-conditioning system is available. So that in the case of such a cold start of the vehicle, a heating up of the vehicle interior is rapidly possible, an electrically operated heating device of the type described above can come into use. If, on the contrary, at the cold start of the vehicle a rapid cooling of the vehicle interior is desired, the refrigeration circuit of the vehicle air-conditioning system is activated, which, however, must first run through a start-up phase before it can perceptibly extract heat from the air flow via the evaporator. During this start-up phase, firstly the thermodynamic conditions for the functioning of the circuit process running in the refrigeration circuit must be created in the refrigeration circuit. Proceeding from a rest phase of the refrigeration circuit, in which the essential components of the refrigeration circuit have ambient temperature, therefore via a corresponding circulation of the refrigerant, the evaporator must be cooled down and the condenser must be heated up. In other words, the entire thermal mass of the refrigeration circuit must be moved from the equilibrium occurring in the rest phase. Hereby, the refrigeration circuit has a certain thermal inertia. Only when the refrigeration circuit reaches a cooling operation phase with a functioning circuit process after running through the start-up phase can it perceptibly discharge heat from the air flow via the evaporator.

From DE 10 2009 058 673 A1 a thermoelectric heat exchanger is known, which can be used for the heating or cooling of a medium. For this, the thermoelectric heat exchanger is equipped with thermoelectric elements, which can convert an electric current into a heat flow. The thermoelectric elements use here the co-called Peltier effect and can therefore also be designated as Peltier elements. The Peltier elements have two thermally active sides facing away from one another. Depending on the polarity of the direct current applied to the respective Peltier element, a heat flow takes place from the one thermally active side to the other thermally active side or vice versa. By means of the known heat exchanger, therefore according to the polarity of the current applied to the thermoelectric elements, a heating of a first medium and therefore a cooling of a second medium, or vice versa, can be brought about, wherein the first medium and the second medium are coupled to one another in a media-separated manner but transferring heat in the heat exchanger via the thermoelectric elements.

The present invention is concerned with the problem of indicating for a method for operating a vehicle air-conditioning system or respectively for a vehicle air-conditioning system or respectively for a vehicle equipped therewith, an improved embodiment which is distinguished in particular by an increased comfort for the vehicle occupants.

This problem is solved according to the invention by the subjects of the independent claims. Advantageous embodiments are the subject of the dependent claims.

### SUMMARY

The invention is based on the general idea of combining a refrigeration circuit, which has an evaporator for cooling an air flow, with a thermoelectric heating device which can be used for heating the air flow, wherein if necessary during a start-up phase of the refrigeration circuit this heating device is operated as a cooler. As a result, heat can be already be extracted from the air flow during the start-up phase of the refrigeration circuit by means of the thermoelectric heating device, so that immediately after the activating of the refrigeration circuit, a cooling of the air flow which is delivered to the vehicle interior is already able to be realized. Therefore, the cooling of the vehicle interior responds immediately after the refrigeration circuit is put into operation, which is immediately perceptible by the vehicle occupants and is sensed as a gain in comfort. According to the invention, the thermoelectric heating device is therefore operated as a cooler during the activating of the refrigeration circuit, in order to provide a perceptible cooling of the air flow already during, and in fact only during, the start-up phase of the refrigeration circuit, during which a noticeable cooling of the air flow by the evaporator is not yet possible. During the start-up phase, the thermodynamic circuit process arises with phase change of the refrigerant in the evaporator and with phase change of the refrigerant in the condenser. As soon as this circuit process has started up, sufficient cooling capacity can be provided via it, so that an operating of the heating device as a cooler is no longer necessary, which also is not expedient from the point of view of energy. Accordingly, in the invention the thermoelectric heating device is operated if necessary as a cooler exclusively during the start-up phase of the refrigeration circuit.

Such a situation, therefore such a case of need, occurs primarily when the vehicle is heated after a lengthy standstill, for example through irradiation by the sun, and in particular the essential components of the refrigeration circuit, such as for example evaporator, condenser, refrigerant pump and refrigerant, have substantially ambient temperature. During the start-up phase of the refrigeration circuit, a heat displacement takes place within the refrigeration circuit until the thermodynamic conditions are present for a functioning of the refrigeration circuit process. This procedure requires time, so that the cooling by the refrigeration circuit can only set in with a time delay, namely after the start-up phase of the refrigeration circuit. The time necessary for this can be bridged by the proposal according to the invention, because with the operation of the thermoelectric heating device as a cooler, a cooling can be realized virtually immediately, which leads to the stated gain in comfort.

Expediently, the heating device is arranged in the duct downstream of the evaporator, in order to be able to realize the re-heat function if applicable.

According to a preferred embodiment of the method, the heating device is deactivated during a cooling operation phase of the refrigeration circuit, which follows, preferably directly, the start-up phase, or is operated as heating, which delivers heat to the air flow. In the latter case, the heating device is used for realizing the above-mentioned re-heat function. The cooling operation phase of the refrigeration circuit is present as soon as heat can be perceptibly extracted from the air flow via the evaporator. This is generally the case when the circuit process functions with the phase changing of the refrigerant. As the thermal output of such a refrigeration circuit is distinctly greater than the thermal output of such a thermoelectric heating device, the cooling capacity which is additionally achievable by means of the heating device is no longer required with regard to the overall efficiency in terms of energy of the vehicle air-conditioning system, as soon as the refrigeration circuit reaches its cooling operation phase. This cooling operation phase comprises on the one hand a nominal operating phase of the refrigeration circuit, which is designed for a continuous operation of the refrigeration circuit, and a transient operating phase, which continues from the start-up phase up to the nominal operating phase. In other words, the refrigeration circuit can already bring about a significant cooling of the air flow after the start-up phase and before its nominal operating phase, so that already after a comparatively short time the heating device no longer has to be operated as a cooler.

According to an advantageous embodiment, the heating device can be operated as a cooler until a cooling capacity of the refrigeration circuit reaches a predetermined performance threshold value. The heating device is then deactivated, as soon as the cooling capacity of the refrigeration circuit reaches this performance threshold value. A suitable control device can monitor for example at least one parameter correlating with the cooling capacity, in order to be able to establish that the performance threshold value is reached. Such a parameter can be, for example, the current temperature difference between the non-cooled air flow and the evaporator, or the current temperature difference between the non-cooled air flow and the refrigerant upstream of the evaporator.

An embodiment is expedient, in which the heating device is operated with direct current, wherein the heating device, for operating as heating, is supplied with a first polarity with direct current, whereas for operating as a cooler it is supplied with a second polarity, inverse to the first polarity, with direct current. In other words, the heating device operates with at least one thermoelectric element which converts electric current into thermal flow, wherein the direction of the thermal flow within the thermoelectric element is determined by the polarity of the direct current applied thereto.

The operating method according to the invention preferably comes into use during a cold start of the vehicle, therefore when essential components of the vehicle have substantially ambient temperature. A cooling requirement for the vehicle interior exists at the cold start of the vehicle for example when the vehicle was exposed to irradiation by the sun, whereby comparatively high temperatures can arise in the vehicle interior. In modern vehicles, the vehicle air-conditioning system is equipped with a “cool-down function” or respectively with a “cool-max function”, which can be switched on manually by the vehicle driver, in order to cool the vehicle interior down as rapidly as possible to a comfortable temperature. According to an advantageous embodiment, provision can be made that the additional cooling of the air flow during the start-up phase of the refrigeration circuit via the thermoelectric heating device is carried out only when the above-mentioned cool-down function is activated. If this cool-down function is not activated, the refrigeration circuit is indeed likewise activated for cooling the vehicle interior, but the cooling of the air stream which accompanies this takes place only after the start-up phase, therefore is chronologically delayed. Hereby, a saving can be made with regard to electrical energy. The cool-down function can be activated e.g. manually by the vehicle user, e.g. via a corresponding operating element on the instrument panel of the vehicle. If the vehicle user requires the increased comfort, he can bring about the immediate start-up of the cooling by actuating the cool-down function, so that the heating device is operated as a cooler in accordance with the operating method described above, during the start-up phase of the refrigeration circuit.

In another embodiment, additionally or alternatively to the manual activation, an automatic activation of the cool-down function can also be provided, for example when a temperature difference is present between the current temperature of the vehicle interior and the desired target temperature for the vehicle interior, which temperature difference is greater than a predetermined and preferably adjustable temperature difference threshold value. For example, provision can be made that the cool-down function on activating the refrigeration circuit is automatically switched on when the temperature difference between actual temperature and target temperature of the vehicle interior is greater than 10° C. or greater than 15° C. or greater than 20° C.

A vehicle air-conditioning system according to the invention, which serves for air-conditioning a vehicle interior, is equipped with at least one duct for directing an air flow to the vehicle interior. In addition, the vehicle air-conditioning system comprises a refrigeration circuit, in which a refrigerant circulates, and which has an evaporator, arranged in the duct, for cooling the air flow. In addition, the vehicle air-conditioning system is equipped with a thermoelectric heating device, likewise arranged in the duct, for heating the air flow. Finally, the vehicle air-conditioning system is equipped with a control for operating the vehicle air-conditioning system, which control is coupled to the refrigeration circuit and to the heating device and which, furthermore, is equipped or respectively programmed so that it can actuate the vehicle air-conditioning system for carrying out the operating method described above.

Expediently, the heating device is arranged in the air path downstream of the evaporator in order, if applicable, to be able to realize the above-mentioned re-heat function.

According to an advantageous further development, the heating device can have at least one thermoelectric element, which converts an electric current into a thermal flow. Here, the direction of the thermal flow is dependent on the polarity of the electric current applied to the respective thermoelectric element, this being a direct current, therefore heat can be delivered to the air flow or can be extracted from the air flow according to the polarity of the direct current with which the respective thermoelectric element is operated.

In another embodiment, the heating device can have a heat exchanger, which is integrated into a cooling circuit in which a coolant circulates and which serves for cooling at least one component of the vehicle. For example, the vehicle can be equipped with an electric drive in which a comparatively large amount of heat occurs during operation. The electric drive can be cooled by means of the cooling circuit. Components with a cooling requirement of such an electric drive are, for example, an electric motor, a battery and power electronics. The active cooling of these components increases, on the one hand, the lifespan of these components, and on the other hand the operating duration, in particular the range of the vehicle.

In a particularly advantageous further development, at least one thermoelectric element of the above-mentioned type can be integrated into the above-mentioned heat exchanger. In this case, the heating device is integrated on the one hand into the air path of the vehicle air-conditioning system, and on the other hand into the cooling circuit, whereby the overall balance with regard to energy of a vehicle equipped therewith can be improved. The heating device can then be configured in particular as the thermoelectric heat exchanger known from DE 10 2009 058 673 A1.

In another embodiment, the evaporator and the heating device can be arranged in a shared housing. Hereby, the heating device is an integral component of an air-conditioning unit which contains the duct, the evaporator and the heating device in a shared housing. Expediently, valve arrangements and suchlike are also accommodated in this housing, by which a mixture ratio of hot air and cold air on the one hand, and a mixture ratio of fresh air and circulating air on the other hand, can be adjusted. Likewise, by means of such valve arrangements the distribution of the air-conditioned air flow to various air vents can be controlled. In addition, by means of such valve arrangements, a two- or multi-zone operation can also be realized. Likewise, a control device for operating the vehicle air-conditioning system can be arranged in this housing.

A vehicle according to the invention comprises a vehicle interior and a vehicle air-conditioning system of the type described above. The vehicle is equipped in addition with an electric drive, which is cooled by means of a cooling circuit, in which a coolant circulates and which has a heat exchanger arranged in the duct of the vehicle air-conditioning system. In this way, by means of the waste heat of the electric drive, the air flow can be heated.

According to a particularly advantageous further development of this vehicle, the heat exchanger of the cooling circuit can be a component part of the thermoelectric heating device of the vehicle air-conditioning system. In particular, the thermoelectric heating device consists of the heat exchanger, into which at least one thermoelectric element is integrated.

The electric drive of the vehicle comprises expediently at least one electric motor, at least one battery and at least one item of power electronics. At least one of these components can be cooled by means of the cooling circuit. Expediently, both electric motor, battery as well as power electronics are cooled by means of the cooling circuit.

A thermoelectric heating device, which is arranged downstream of an evaporator of a refrigeration circuit, can be used according to the invention during a start-up phase of the refrigeration circuit for cooling an air flow. Hereby, as shown, an increase in comfort can be realized, because the refrigeration circuit immediately responds perceptibly for the vehicle occupant.

Further important features and advantages of the invention will emerge from the subclaims, from the drawings and from the associated figure description with the aid of the drawings.

It shall be understood that the features mentioned above and to be explained further below are able to be used not only in the respectively indicated combination, but also in other combinations or in isolation, without departing from the scope of the present invention.

Preferred example embodiments of the invention are illustrated in the drawings and are explained further in the following description.

### BRIEF DESCRIPTION OF THE DRAWINGS

The FIGURE shows a schematic diagram in the manner of a circuit diagram of a vehicle which is equipped with a vehicle air-conditioning system.

### DETAILED DESCRIPTION

According to the FIGURE, a vehicle 1 comprises a vehicle interior 2 and a vehicle air-conditioning system 3 for air-conditioning the vehicle interior 2, and an electric drive 4. The vehicle 1 can be configured here as an electric vehicle, which has only this electric drive 4 for driving the vehicle 1. Likewise, the vehicle 1 can be configured as a hybrid vehicle, which has the electric drive 4 in addition to an internal combustion engine, which is not shown here, for driving the vehicle 1. Likewise, a hybrid vehicle is conceivable, in which an internal combustion engine comes into use as a so-called range extender, in order to provide electric current for operating the electric drive 4, so that the drive of the vehicle takes place by the electric drive and not by the internal combustion engine.

The vehicle 1 is in addition equipped with a cooling circuit 5, which serves for cooling the electric drive 4. In the example, the electric drive 4 has at least one electric motor 6, at least one battery 7 and an item of power electronics 8, which controls an electrical supply of the electric motor 6 with electric power from the battery 7. Likewise, the power electronics 8 can control a charging of the battery 7 during a generator operation of the electric motor 6.

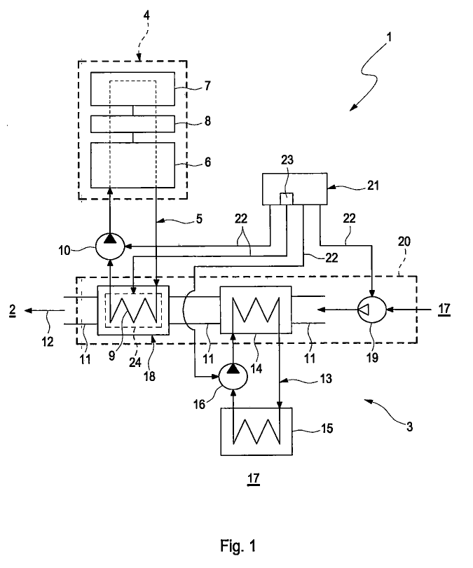

The cooling circuit 5 is likewise coupled to a component of the electric drive 4 in a heat-transmitting manner, in order to bring about a cooling of the respective component. In the example of FIG. 1, the cooling circuit 5 is coupled to all three components which are shown, therefore to the electric motor 6, to the battery 7 and to the power electronics 8, in a heat-transmitting manner. A coolant circulates in the cooling circuit 5. In addition, the cooling circuit 5 contains a heat exchanger 9 and a coolant pump 10 for driving the coolant in the cooling circuit 5.

The vehicle air-conditioning system 3, which can also be designated below in abbreviated form as air-conditioning system 3, comprises at least one duct 11 for directing an air flow 12, indicated by an arrow, to the vehicle interior 2. In addition, the air-conditioning system 3 is equipped with a refrigeration circuit 13, in which a refrigerant circulates, which circuit has an evaporator 14, a condenser 15 and a refrigerant pump 16. The evaporator 14 is arranged in the duct 11 and serves for cooling the air flow 12. The condenser 15 directs the heat, extracted from the air flow 12, to an environment 17 of the vehicle 1.

The air-conditioning system 3 comprises in addition a thermoelectric heating device 18, which is likewise arranged in the duct 11 and is expediently arranged here downstream of the evaporator 14 with respect to the air flow 12. The heating device 18 serves for heating the air flow 12. In addition, the air-conditioning system 3 is equipped with a fan 19, which drives the air flow 12. For example, air can be drawn in from the environment 17 by means of the fan 19.

In the example of FIG. 1, the air-conditioning system 3 has a shared housing 20 for the heating device 18, the evaporator 14 and the fan 19.

Furthermore, the air-conditioning system 3 is equipped with a control device 21, which serves to operate the air-conditioning system 3 and which, for this, is coupled in a suitable manner to all controllable components of the air-conditioning system 3. Control lines 22, via which the control device 21 is connected to the heating device 18, the coolant pump 10, the refrigerant pump 16 and the fan 19, are indicated in FIG. 1. The control device 21 is coupled, in addition, to a further item of power electronics 23, which serves for operating the heating device 18. In the example of FIG. 1, this item of power electronics 23 is integrated into the control device 21.

It is clear that the control device 21 is basically coupled to further components of the air-conditioning system 3, such as for example to a temperature sensor system, not shown here, which can measure for example the current actual temperature of the vehicle interior 2. In particular, thereby also a current temperature difference between the actual temperature and target temperature of the vehicle interior 2 can be determined.

The heating device 18 has at least one thermoelectric element 24, which is configured as a Peltier element and which accordingly converts an electric current into a thermal flow. Usually, the heating device 18 contains a plurality of such thermoelectric elements 24.

In addition, in the example the heat exchanger 9 of the cooling circuit 5 is likewise integrated into the duct 11 of the air-conditioning system 3, and namely downstream of the evaporator 14. According to the particularly advantageous embodiment which is shown here, this heat exchanger 9 forms a component of the heating device 18, such that the respective thermoelectric element 24 is integrated into the heat exchanger 9. In this way, on the one hand by means of the cooling circuit 5 the air flow 12 can be heated. On the other hand, by means of the respective thermoelectric element 24, heat can either be transferred from the air flow 12 to the coolant or from the coolant to the air flow 12.

In the case of a cold start of the vehicle 1, it can be necessary to cool the vehicle interior 2 down to a comfortable temperature as rapidly as possible. For this, a cool-down function can be initiated or respectively activated either by the respective vehicle occupant manually or via the control device 21 automatically. This includes on the one hand an activating of the refrigeration circuit 13 and on the other hand an operating of the heating device 18 as cooler during a start-up phase of the refrigeration circuit 13. In other words, the heating device 18, provided per se for heating, is used as a cooler during the start-up phase of the refrigeration circuit 13. During this start-up phase, the thermodynamic equilibrium which occurs in the refrigeration circuit 13 in the deactivated state, must be shifted in order to start the thermodynamic circuit process, which during a cooling operating phase of the refrigeration circuit 13 enables an efficient heat absorption through the respective phase change of the refrigerant in the evaporator 14, and enables an efficient heat emission in the condenser 15. During this start-up phase of the refrigeration circuit 13, however, no appreciable cooling of the air flow 12, perceptible by the vehicle occupants in the vehicle interior 2, is possible. To increase the comfort, the heating device 18 is actuated by the control device 21 as a cooler during the cool-down operation. This takes place for example through a corresponding current feed of the respective thermoelectric element 24. For example, the heating device 18 or respectively the respective thermoelectric element 24 is supplied with direct current for operating as heating with a first polarity, whereas the heating device 18 or respectively the respective thermoelectric element 24 for operating as a cooler is supplied with a second polarity with direct current, which is contrary to the first polarity, therefore is inverse. In so far as the cool-down function is thus activated, during the start-up phase of the refrigeration circuit 13 the air flow 12 is cooled by means of the heating device 18, which is operated as a cooler, for this, by the control device 18. As this cool-down function is carried out in particular at a cold start of the vehicle 1, generally no cooling requirement is yet present for the electric drive 4, so that a heat emission into the coolant of the cooling circuit 5 is possible. In particular therefore also the cooling circuit 5 can be used for cooling the air flow 12.

As soon as the refrigeration circuit 13 leaves its start-up phase and reaches its cooling operation phase, the heating device 18 is deactivated by the control device 21. As soon as the refrigeration circuit 13 has reached its nominal operating phase and the cool-down function is deactivated, the heating device 18 can be operated as heating by means of the control device 21 to realize a re-heat function. However, as soon as sufficient waste heat occurs in the electric drive 4, this re-heat function can also be realized via the cooling circuit 5 therefore in connection with the heat exchanger 9, so that the respective thermoelectric element 24 can be deactivated.

For example, the heating device 18 can be operated as a cooler until a cooling capacity of the refrigeration circuit 13 reaches a predetermined performance threshold value. When this performance threshold value is then reached, a deactivation of the heating device 18 takes place, therefore a deactivation of the cooling function of the heating device 18.

The cool-down function can be deactivated manually by the vehicle occupant. It can also be deactivated in a time-controlled manner. Likewise, it is conceivable to deactivate the cool-down function in a temperature-controlled manner, for example provision can be made to deactivate the cool-down function as soon as the temperature difference between actual temperature and target temperature in the vehicle interior 2 is less than 5° C.

Basically, it is conceivable to design the control device 21 so that on each putting into operation of the refrigeration circuit 13, the heating device 18 is operated as a cooler during the start-up phase. However, a more favourable embodiment with regard to energy is preferred, in which on activating of the refrigeration circuit 13 during the start-up phase the heating device 18 is only operated as a cooler when the above-mentioned cool-down function is activated. This can be activated for example automatically by the control device 21, when a temperature difference is present between the current actual temperature of the vehicle interior 2 and the target temperature of the interior 2 desired by the vehicle driver, which temperature difference is greater than a predetermined temperature difference which can be, for example, 10° C.

1. A vehicle comprising:
a vehicle interior;
an electric drive for driving the vehicle, the electric drive including at least one electric motor, at least one battery and at least one power electronic, the electric drive cooled via a cooling circuit, the cooling circuit configured to circulate a coolant and including a heat exchanger;
a vehicle air-conditioning system including:
at least one duct for directing an air flow to the vehicle interior;
a refrigeration circuit configured to circulate a refrigerant and including an evaporator, the refrigeration circuit arranged in the at least one duct for cooling the air flow;
a thermoelectric heating device arranged in the at least one duct for heating the air flow;
a control device configured to operate the vehicle air-conditioning system coupled to the refrigeration circuit and to the thermoelectric heating device;
the control device at least one of configured and programmed to actuate the vehicle air-conditioning system,
wherein the control device is operable to:
activate the refrigeration circuit to cool the vehicle interior;
operate the thermoelectric heating device as a cooler during a start-up phase of the refrigeration circuit, the thermoelectric heating device extracting heat from the air flow;
operate the thermoelectric heating device only as the cooler during the start-up phase of the refrigeration circuit when a cool-down function is activated; and
automatically activate the cool-down function when a temperature difference between an actual temperature of the vehicle interior and a target temperature of the vehicle interior exceeds a predetermined temperature difference threshold value;
wherein the heat exchanger of the cooling circuit is arranged in the at least one duct of the vehicle air-conditioning system and is a component of the thermoelectric heating device of the vehicle air-conditioning system.

2. The vehicle according to claim 1, wherein
the thermoelectric heating device includes at least one thermoelectric element configured to convert an electric current into a thermal flow.

3. The vehicle according to claim 1, wherein
the thermoelectric heating device includes the heat exchanger integrated into the cooling circuit where the coolant to cool at least one vehicle component.

4. The vehicle according to claim 2, wherein
the at least one thermoelectric element is integrated into the heat exchanger.

5. The vehicle according to claim 1, wherein
the evaporator and the thermoelectric heating device are arranged in a shared housing.

6. The vehicle according to claim 1, wherein
the control device is further operable to deactivate the thermoelectric heating device during a cooling operation phase of the refrigeration circuit, following the start-up phase, or the thermoelectric heating device operates to deliver heat to the air flow.

7. The vehicle according to claim 1, wherein the control device is further operable to:
operate the thermoelectric heating device as the cooler until a cooling capacity of the refrigeration circuit reaches a predetermined performance threshold value, and
end operation of the thermoelectric heating device as the cooler when the cooling capacity of the refrigeration circuit reaches the performance threshold value.

8. The vehicle according to claim 1, wherein the control device is further operable to:
operate the thermoelectric heating device with direct current, wherein the thermoelectric heating device is configured for heating via supplying the direct current with a first polarity, and is configured as the cooler when the direct current is supplied with a second polarity, inverse to the first polarity.

9. The vehicle according to claim 1, wherein the operating method further comprises deactivating the thermoelectric heating device during a cooling operation phase of the refrigeration circuit, following the start-up phase.

10. The vehicle according to claim 1, wherein the operating method further comprises operating the thermoelectric heating device to deliver heat to the air flow.

11. The vehicle according to claim 1, wherein the cooling circuit is coupled to the electric motor, the battery, and the power electronics in a heat-transmitting matter.

12. The vehicle according to claim 1, wherein the cooling circuit further includes a coolant pump configured to drive the coolant in the cooling circuit.

13. The vehicle according to claim 1, wherein the air-conditioning system further comprises a condenser.

14. The vehicle according to claim 1, wherein the air-conditioning system further comprises a refrigerant pump.

15. The vehicle according to claim 1, wherein the air-conditioning system further comprises a fan configured to drive the air flow.

16. The vehicle according to claim 15, wherein the fan is disposed in the shared housing.

17. The vehicle according to claim 1, wherein the thermoelectric heating device is arranged downstream of the evaporator with respect to the air flow.

18. The vehicle according to claim 1, wherein the control device is coupled to one other power electronic configured to operate the thermoelectric heating device.

19. The vehicle according to claim 18, wherein the one other power electronic is integrated into the control device.

20. A vehicle comprising:
a vehicle interior;
an electric drive for driving the vehicle, the electric drive including at least one electric motor, at least one battery and at least one power electronic, the electric drive cooled via a cooling circuit, the cooling circuit configured to circulate a coolant and including a heat exchanger;
a vehicle air-conditioning system including:
at least one duct for directing an air flow to the vehicle interior;
a refrigeration circuit configured to circulate a refrigerant and including an evaporator, the refrigeration circuit arranged in the at least one duct for cooling the air flow;
a thermoelectric heating device arranged in the at least one duct for heating the air flow;
a control device configured to operate the vehicle air-conditioning system coupled to the refrigeration circuit and to the thermoelectric heating device;
the control device at least one of configured and programmed to actuate the vehicle air-conditioning system, wherein the control device is operable to:
activate the refrigeration circuit to cool the vehicle interior;
operate the thermoelectric heating device as a cooler during a start-up phase of the refrigeration circuit, the thermoelectric heating device extracting heat from the air flow;
operate the thermoelectric heating device only as the cooler during the start-up phase of the refrigeration circuit when a cool-down function is activated; and
automatically activate the cool-down function when a temperature difference between an actual temperature of the vehicle interior and a target temperature of the vehicle interior exceeds a predetermined temperature difference threshold value;
wherein the heat exchanger of the cooling circuit is arranged in the at least one duct of the vehicle air-conditioning system and is a component of the thermoelectric heating device of the vehicle air-conditioning system; and
wherein the evaporator and the thermoelectric heating device are arranged in a shared housing.
